(19) United States
(12) Patent Application Publication
(10) Pub. No.: US 2009/0162567 A1
(43) Pub. Date: Jun. 25, 2009

(54) METHOD FOR MANUFACTURING HIGH PERFORMANCE PHOTOCATALYTIC FILTER

(75) Inventors: YAO-HSUAN TSENG, Taoyuan County (TW); CHIA-HUNG HUANG, Taipei County (TW); CHIEN-SHENG KUO, Tainan County (TW); YAO-LING HUANG, Hsinchu City (TW); SHU-LING LIU, Miaoli County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/176,644

(22) Filed: Jul. 21, 2008

(30) Foreign Application Priority Data
Dec. 19, 2007 (TW) 96148592

(51) Int. Cl. B05D 3/00

(52) U.S. Cl. 427/541

(57) ABSTRACT

A method for manufacturing high performance photocatalytic filters is disclosed, which comprises the steps of: preparation of a photocatalytic material selected from a titanium dioxide (TiO₂), a zinc oxide (ZnO), a tin dioxide (SnO₂) and the mixtures thereof; metal-modification of the photocatalytic material with using the photo-deposition method, such as silver (Ag), gold (Au) or platinum (Pt), so as to enable the photocatalytic material to have a good photocatalytic activity and thus enable the as-prepared photocatalytic filter to photocatalytically degrade various volatile organic compounds (VOCs) and non-organic gases as well as all kinds of pollutants. The photocatalytic filter made of the aforesaid photocatalytic material enjoys a comparatively longer lifespan with persisting catalytic activity, and can be easily regenerated by a water-washing process.

### FIELD OF THE INVENTION

The present invention relates to a method for manufacturing high performance photocatalytic filter, and more particularly, to a manufacturing method capable of using a photo-deposition process to deposit a metal on a filter made of a photocatalytic material for modifying the same.

### BACKGROUND OF THE INVENTION

In most air purifiers, activated carbon and zeolite are the most common absorbents used for absorbing pollutants floating in air. However, as the activated carbon and zeolite that are used as the absorbents in an air filter have limited lifespan and are ineffective for absorbing pollutants of low molecular or low concentration, moreover, they can be deactivated and easy to fall off from the filter after they are saturated, the air filter has to be replaced regularly that not only the cost of air purification is increased, but also the used filters saturated with pollutants must be processed with special care as they can be hazardous for environment.

There are already many studies focus their efforts on the solving of the aforesaid shortcomings relating to the use of activated carbon and zeolite as absorbents in air purification. One of which is a Photocatalyst composition disclosed in U.S. Pat. Pub. No. 20030050196, entitled “Photocatalyst compositions and methods for making the same”, which is substantially a porous substrate having a photocatalyst layer deposited thereon while the photocatalyst layer is being metal modified by the use of an impregnation method. However, any air filter made from the aforesaid photocatalyst composition is disadvantageous in that: the photocatalyst layer, such as TiO2, that is deposited on the porous substrate can fall off from the substrate easily after it is saturated, and moreover, it can not be regenerated.

Another such study is a filter disclosed in Japanese Patent Laid-Open Publication No. 2000-107270, entitled “Antimicrobial and deodorant filter”, in which filters of different structures are adopted as substrates provided for a photocatalyst powder to deposit thereon, and then the filters are metal modified for enabling silver ions to attach onto the surface of the photocatalyst layer by the use of an impregnation method for enhancing the performance of the filters. However, any aforesaid air filter is also disadvantageous in that: the photocatalyst layer, such as TiO2, can fall off from the filter easily after it is saturated, and moreover, it can not be regenerated.

One another such study is a filter disclosed in Japanese Patent Laid-Open Publication No. 2000-070673, entitled “Antibacterial deodorizing photocatalyst type filter and its production”, in which the photocatalyst powder is first being metal modified by the use of an impregnation method for depositing a metal, such as silver or copper, and then it is made into a filter. Although the antibacterial efficiency of the metal-modified photocatalyst powder is greatly improved by the silver ions, it is still disadvantageous in that: the photocatalyst powder can fall off from the filter easily after it is saturated, and moreover, it can not be regenerated.

Yet, another such study is a filter disclosed in Japanese Patent Laid-Open Publication No. Heisei 11-276910, entitled “Air purification filter and its production”, in which a photocatalyst material is first being deposited on a filter made of different materials, such as acrylic or nylon, and then it is metal-modified for enhancing its activity. Nevertheless, in this patent, only the idea of metal modification is provided but it did not provide an achievable method illustrating how to perform the metal modification. In addition, the aforesaid patent also is disadvantageous in that: the photocatalyst powder, such as TiO2, can fall off from the filter easily after it is saturated, and moreover, it can not be regenerated.

From the above description, it is noted that in spite of the common knowledge of using the deposition of a metal on a photocatalyst layer for modifying the same, the metal modification is mostly being performed by the use of an impregnation method that consequently cause the aforesaid fall-off and unregeneration problems to the filter. Therefore, it is intended in this patent to provide a method for depositing a metal on a photocatalyst layer by the use of a photo-deposition process.

### SUMMARY OF THE INVENTION

The object of the present invention is to provide a method for manufacturing high performance photocatalytic filter, by which the photocatalytic filter can have good photocatalytic activity and thus enable the as-prepared photocatalytic filter to photocatalytically degrade various volatile organic compounds (VOCs) and non-organic gases as well as all kinds of pollutants. In addition, the photocatalytic filter made of the aforesaid photocatalytic material enjoys a comparatively longer lifespan with persisting catalytic activity, and can be easily regenerated by a water-washing process.

To achieve the above object, the present invention provide a method for manufacturing high performance photocatalytic filter, which comprises the steps of: preparing a photocatalytic filter containing a photocatalytic material selected from a titanium dioxide (TiO₂), a zinc oxide (ZnO), a tin dioxide (SnO₂) and the mixtures thereof; metal-modifying the photocatalytic filter by the use of a photo-deposition process for depositing a metal, such as silver (Ag), gold (Au) or platinum (Pt), on the photocatalytic filter.

In an exemplary embodiment of the invention, the preparation of the photocatalytic filter is to provide a filter, made of a non-woven fabric or a ceramics, while attaching the photocatalytic material on the filter by coating or impregnating.

Moreover, the filter can be a porous ceramics filter made of a mixture of aluminum oxide and silicon carbide at any ratio, and having a porosity ranged between 5 ppi and 50 ppi. In addition, the depositing of the photocatalytic material onto the filter is performed by impregnating the filter in a sol-gel containing the photocatalytic material, whereas the photocatalytic material is a material selected from a titanium dioxide (TiO₂), a zinc oxide (ZnO), a tin dioxide (SnO₂) and the mixtures thereof, while enabling the photocatalyst content of the sol-gel to be ranged between 0.01 wt % and 50 wt % and the grain-diameter of each selected photocatalytic material powder to be ranged between 5 nm and 1 um.

In addition, the metal modification of the photocatalytic filter by the use of photo-deposition process comprises the steps of: preparing an aqueous solution of a metal salt whereas the metal salt is a metal selected from the group consisting of: silver (Ag), Gold (Au), platinum (Pt), palladium (Pd), copper (Cu), nickel (Ni), cobalt (Co), iron (Fe), ruthenium (Ru), niobium (Nb), iridium (Ir), vanadium (V) and the like; submerging the photocatalytic filter in the aqueous solution for performing a photo-deposition process thereon; illuminating the submerged photocatalytic filter containing the photocatalytic material with an ultraviolet light for enabling the photocatalytic material to generate activated electrons; using the activated electron to reduce metal ions containing in the aqueous solution and thus cause the reduced metal to deposit on the surface of the photocatalytic filter; repetitively performing a water-washing process and a centrifugal process on the photocatalytic filter; and drying the photocatalytic filter so as to obtain a metal-modified photocatalytic filter.

It is emphasized that the method for manufacturing high performance photocatalytic filter can be adapted for photo-depositing a metal onto any conventional photocatalytic filter that is currently available on the market and thus modifying the same.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a flow chart illustrating the steps of a method for manufacturing high performance photocatalytic filter according to an exemplary embodiment of the invention.

FIG. 2 is a flow chart illustrating the steps for preparing a photocatalytic filter according to the present invention.

FIG. 3 is a flow chart illustrating the steps for photo-depositing a metal onto the photocatalytic filter for modifying the same according to the present invention.

FIG. 4 is a diagram showing the effect of using a photocatalytic filter that is not metal-modified for degradation of H₂S.

FIG. 5 is a diagram showing the effect of using a metal-modified photocatalytic filter of the invention for degradation of H₂S.

FIG. 6 is a diagram comparing the photocatalytic activities of a photocatalytic filter that is not metal-modified with those that are metal-modified by silver, platinum and palladium in respective.

FIG. 7 is a diagram comparing the NOₓ removal ability of an unused photocatalytic filter of the invention with those that are used but had been regenerated by the water-washing process.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

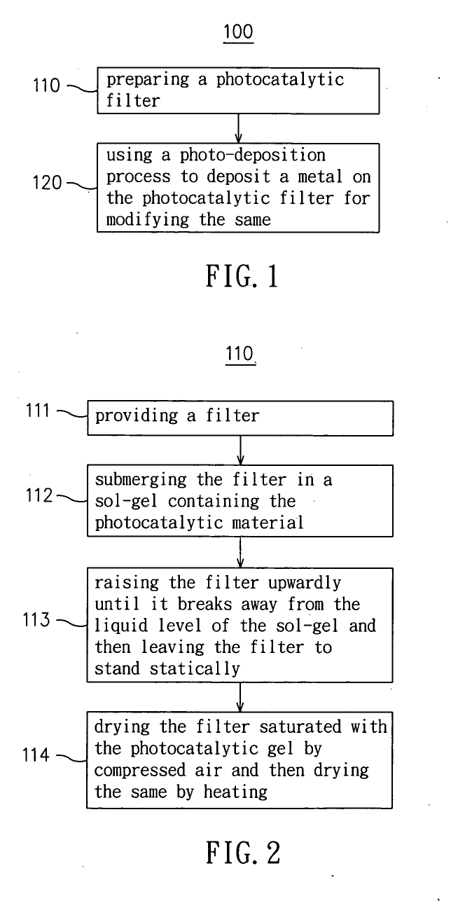

Please refer to FIG. 1, which is a flow chart illustrating the steps of a method for manufacturing high performance photocatalytic filter according to an exemplary embodiment of the invention. The manufacturing method of FIG. 1 comprises two steps, which are:
Step 110: preparing a photocatalytic filter; and
Step 120: metal-modifying the photocatalytic filter by the use of a photo-deposition process for depositing a metal on the photocatalytic filter for modifying the same.

In an exemplary embodiment of the invention, the preparation of the photocatalytic filter is first to provide a filter, made of a non-woven fabric or a ceramics, and then attaching a photocatalytic material on the filter by coating or impregnating so as to form a photocatalytic filter. Although the photocatalytic filter can be formed by coating or impregnating, only the process relating to the manufacturing of the photocatalytic filter by impregnating is provided, as those shown in FIG. 2, which comprises the steps of:
Step 111: providing a filter, whereas the filter can be made of a non-woven fabric or a ceramics; in this embodiment, the filter is a porous ceramics filter made of a mixture of aluminum oxide and silicon carbide at any ratio, and having a porosity ranged between 5 ppi and 50 ppi;
Step 112: submerging the filter in a sol-gel containing the photocatalytic material as the filter is a porous ceramics filter made of a mixture of aluminum oxide and silicon carbide, and the porosity of the porous ceramics filter is ranged between 5 ppi and 50 ppi, and the photocatalytic material contained in the sol-gel is a material selected from a titanium dioxide (TiO₂), a zinc oxide (ZnO), a tin dioxide (SnO₂) and the mixtures thereof, while enabling the photocatalyst content of the sol-gel to be ranged between 0.01 wt % and 50 wt % and the grain-diameter of each selected photocatalytic material powder to be ranged between 5 nm and 1 um.; moreover, the size of the filter, the amount of the sol-gel required and the duration of the submerged are all dependent upon actual requirement that, for example, the filter, being a ceramics filter of 30×30×2 cm³ in size, is submerged in a sol-gel of 20 liters for about 5 minutes for enabling the sol-gel to fill uniformly and fully in every aperture of the ceramics filter while the sol-gel is prepared according to the method disclosed in TW Pat. No. 1230690 and US publication Pat. No. 2007-0149393;
Step 113: raising the filter upwardly until it breaks away from the liquid level of the sol-gel and then leaving the filter to stand statically; in which the speed of the raising and the duration that the filter is left to stand are dependent upon actual requirement that, for example, after the filter is submerged in the sol-gel for about 5 minutes, the 30×30×2 cm³ ceramics filter is raised upwardly at a speed of 1 cm to 20 cm per minute and is then being left to stand statically for about 5 minutes after it breaks away from the liquid level of the sol-gel for enabling the sol-gel to cover the whole surface of the ceramics filer uniformly while leaving the excess sol-gel to drip away from the filter; and
Step 114: drying the filter saturated with the photocatalytic gel by compressed air and then drying the same by heating; in which the heating temperature and the heating time are dependent upon actual requirement that, for example, the drying of the 30×30×2 cm³ ceramics filter is performed by blow-drying the ceramics filter impregnated with the sol-gel by compressed air and then placing the ceramics filter in an oven for baking the same for a period of time ranged between four and twenty-four hours at a temperature between 150 to 600° C. so as to fix the photocatalytic material on the surface of the ceramics filter.

It is noted that although the aforesaid photocatalytic filter is manufactured by an impregnation process, other photocatalytic filters of other manufacturing methods can also be used in the aforesaid step 120 where it is metal modified by the use of the photo-deposition process for depositing a metal on the photocatalytic filter for modifying the same.

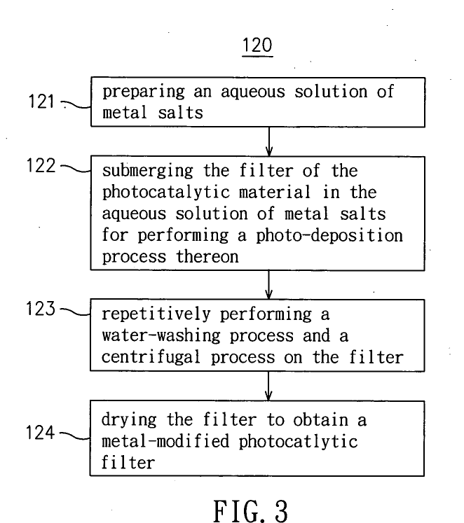

In addition, please refer to FIG. 3, which is a flow chart illustrating the steps for photo-depositing a metal onto the photocatalytic filter for modifying the same according to the present invention, as those performed in t the step 120 of FIG. 1. The metal modification process of FIG. 3 comprises the steps of:
Step 121: preparing an aqueous solution of a metal salt whereas the metal salt is a metal selected from the group consisting of: silver (Ag), Gold (Au), platinum (Pt), palladium (Pd), copper (Cu), nickel (Ni), cobalt (Co), iron (Fe), ruthenium (Ru), niobium (Nb), iridium (Ir), vanadium (V) and the like, in that, when silver (Ag) is used as the metal salt resolved in the aqueous solution for example, an operator can weight and resolve a proper portion of silver nitrate in the aqueous solution for preparing the concentration of metal ion in the aqueous solution to be ranged between 0.005 and 1N and the pH value of the aqueous solution to be ranged between 6 and 12, wherein the pH value is preferred to be between 7 and 9 in this embodiment;
Step 122: submerging the photocatalytic filter in the aqueous solution of metal salts for performing a photo-deposition process thereon, in which the photocatalytic filter prepared by the step 110 of FIG. 1 is first being submerged in the aqueous solution of step 121, and then it is illuminated by an ultraviolet light for activating the photo-deposition process whereas the ultraviolet light can be an ultraviolet high pressure mercury lamp, a black light tube lamp, a light-emitting diode, or a germicidal lamp whichever is able to emit ultraviolet light of wavelength that is smaller than 390 nm, and is able to the project ultraviolet light on the surface of the photocatalytic filter with an intensity that is higher than 0.2 mW/Cm² while lasting a period of time that is between 0.5 hour and 12 hours; thereby, the photocatalytic material contained in the photocatalytic filter is activated to generate activated electron by the ultraviolet illumination which are going to reduce metal ions containing in the aqueous solution and thus cause the reduced metal to deposit on the surface of the photocatalytic filter;
Step 123: repetitively performing a water-washing process and a centrifugal process on the photocatalytic filter, in which after the water-washing process and centrifugal processes are performed repetitively by two to five times, the metal modification of the photocatalytic filter is completed; and
Step 124: drying the photocatalytic filter so as to obtain a metal-modified photocatalytic filter, in which the drying of the photocatalytic filter is performed by placing the metal-modified photocatalytic filter in an environment with temperature ranged between 60 to 100° C. for a period of time between four to twenty-four hours.

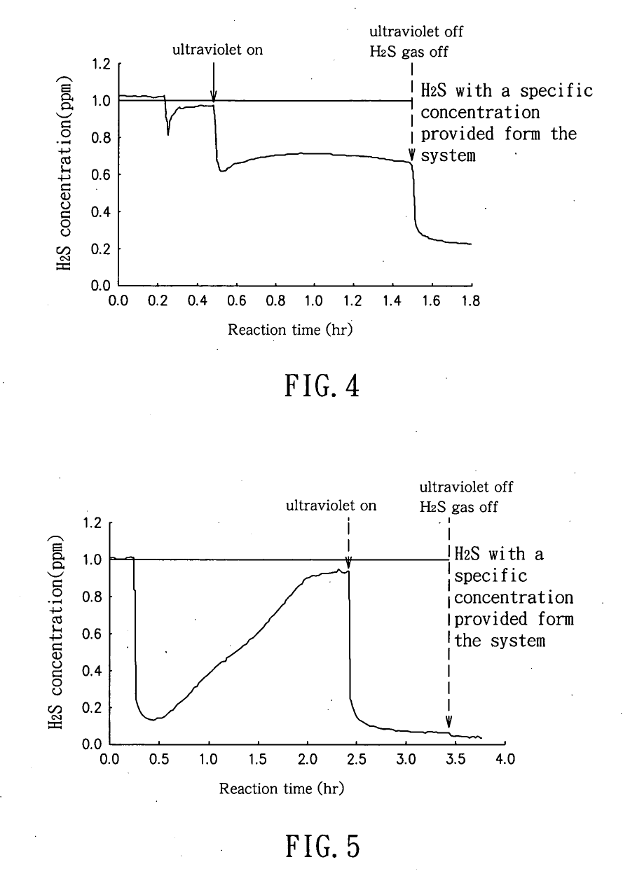

Please refer to FIG. 4 and FIG. 5, which show the effect of using a metal-modified photocatalytic filter of the invention for degradation the concentration of H₂S. The air purification system used for testing the removal rate of H₂S usually is composed of a test gas supply unit, a photocatalytic reactor, and a nitrogen oxides analyzer, in which a test gas is inputted into the photocatalytic reactor configured with a photocatalytic filter where the gas is illuminated by an ultraviolet beam, and then the resulting gas is fed to the nitrogen oxides analyzer for analysis. It is noted that the structure as well as the working principle is known to those skilled in the art and thus are not described further herein. In FIG. 4, the photocatalytic filter used is a conventional photocatalytic filter without being metal-modified and is designed for the purification of gases containing H₂S. As shown in FIG. 4, at the beginning, the H₂S concentration of the test gas is controlled at 1.0 ppm in a flow reaction system which is decreased to about 0.6 ppm when the photocatalytic filter is irradiated by ultraviolet light. It is going to be maintained at about 0.6 ppm for about one hour.

In FIG. 5, the system similar to the one used in FIG. 4 is adopted, but instead of the conventional photocatalytic filter, a metal-modified photocatalytic filter of the invention is used. As shown in FIG. 5, after the ultraviolet light is on, the H₂S concentration is decreased rapidly from 1.0 ppm to about 0.05 ppm. Comparing with the removal effect of FIG. 4, the metal-modified photocatalytic filter of the invention not only illustrates the better absorption ability to H₂S than that of non-modified photocatalytic filter, but also exhibits a good photocatalytic activity than that of non-modified photocatalytic filter. It can be widely used for air purification due to its excellent photocatalytic activity.

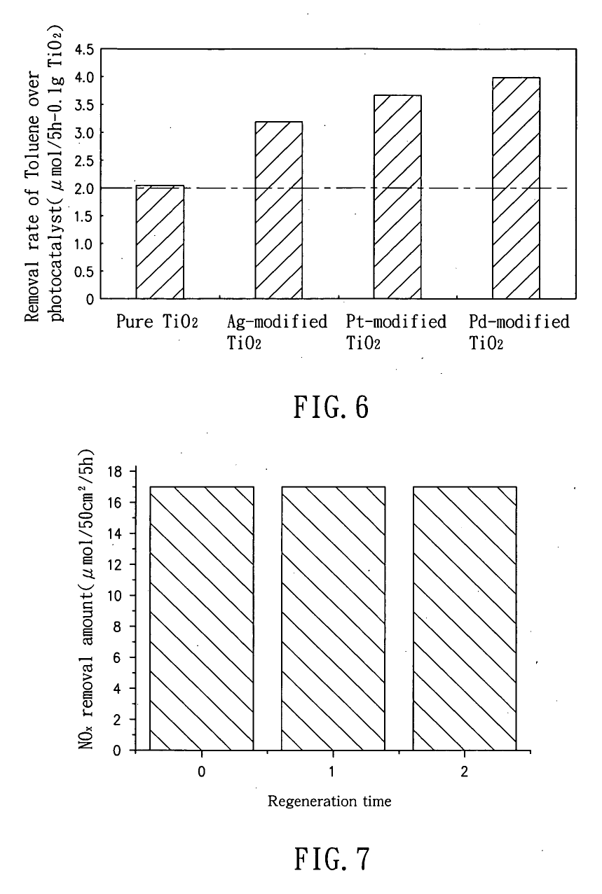

Form the above description, it is noted that the metal capable of being used for modifying photocatalytic filter can be silver (Ag), Gold (Au), platinum (Pt), palladium (Pd), copper (Cu), or the like. Please refer to FIG. 6, which is a diagram comparing the removal rate of Toluene over a photocatalytic filter that is not metal-modified with those that are metal-modified by silver, copper and palladium in respective. In this exemplary embodiment, the photocatalytic material used is TiO₂. In FIG. 6, the photocatalytic activity of the TiO₂ filter without being metal-modified is about 2.0 μmol/5 h, while the photocatalytic activity of the TiO₂ filter being metal-modified by silver is about 3.2 μmol/5 h; the photocatalytic activity of the TiO₂ filter being metal-modified by platinum is about 3.7 μmol/5 h; and the photocatalytic activity of the TiO₂ filter being metal-modified by palladium is about 4.0 μmol/5 h. As the removal rate of Toluene over photocatalytic filers being metal-modified by different metal can be different, it is intended to design a metal-modified photocatalytic filers according to the pollutant that is intended to be degraded.

Since the metal used in the invention for modifying the photocatalytic filter is being deposited on the surface thereof, it illustrates a good durability to the photocatalytic filter. Please refer to FIG. 7, is a diagram comparing the NOₓ removal ability of a fresh photocatalytic filter of the invention with those that are used but had been regenerated by the water-washing process. In FIG. 7, the shadowed area of the zero regeneration time represents that the NOₓ removal ability of a fresh photocatalytic filter is about 17 μmol/50 cm²/5 h; while those photocatalytic filter that had been regenerated one or twice by the water-washing process present a NOₓ removal ability as good as the one that is unused, so that it is known that the photocatalytic filter of the invention has good photocatalytic activity and good immobility.

To sum up, by the method for manufacturing high performance photocatalytic filters disclosed in the invention, the as-prepared photocatalytic material has a good photocatalytic activity and thus enables the as-prepared photocatalytic filter to photocatalytically degrade various volatile organic compounds (VOCs) and non-organic gases as well as all kinds of pollutants. The photocatalytic filter made of the aforesaid photocatalytic material enjoys a comparatively longer lifespan with persisting catalytic activity, and can be easily regenerated by a water-washing process that it is surely the improvement over those conventional photocatalytic filters.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for manufacturing high performance photocatalytic filter, comprising the steps of:
preparing a photocatalytic filter; and
metal-modifying the photocatalytic filter by the use of a photo-deposition process for depositing a metal on the photocatalytic filter for modifying the same;
wherein, the metal modification of the photocatalytic filter further comprises the steps of:
preparing an aqueous solution of a metal salt;
submerging the photocatalytic filter in the aqueous solution for performing the photo-deposition process thereon;
repetitively performing a water-washing process and a centrifugal process on the photocatalytic filter; and
drying the photocatalytic filter.

2. The method of claim 1, wherein the concentration of metal ion in the aqueous solution is ranged between 0.005 and 1N.

3. The method of claim 1, wherein the pH value of the aqueous solution is ranged between 6 and 12.

4. The method of claim 1, wherein the photo-deposition process is activated by illuminating the photocatalytic filter submerged in the aqueous solution by ultraviolet light emitted from a light source whereas the light source is a ultraviolet device selected from the group consisting of: an ultraviolet high pressure mercury lamp, a black light tube lamp, a light-emitting diode, and a germicidal lamp.

5. The method of claim 4, wherein the wavelength of the ultraviolet light is smaller than 390 nm.

6. The method of claim 4, wherein the intensity of the ultraviolet light measured on the surface of the photocatalytic filter is higher than 0.2 mW/cm².

7. The method of claim 4, wherein the duration of the ultraviolet light illuminating on the photocatalytic filter is between 0.5 hour and 12 hours.

8. The method of claim 1, wherein the water-washing process and centrifugal processes are performed repetitively two to five times.

9. The method of claim 1, wherein the drying of the photocatalytic filter is performed by placing the metal-modified photocatalytic filter in an environment with temperature ranged between 60 to 100° C. for a period of time between four to twenty-four hours.

10. The method of claim 1, wherein the metal used for modified the photocatalytic filter is a metal selected from the group consisting of: silver (Ag), Gold (Au), platinum (Pt), palladium (Pd), copper (Cu), nickel (Ni), cobalt (Co), iron (Fe), ruthenium (Ru), niobium (Nb), iridium (Ir), vanadium (V) and the like.

11. A method for manufacturing high performance photocatalytic filter, comprising the steps of:
provide a filter, made of a non-woven fabric or a ceramics, while impregnating the filter in a sol-gel containing a photocatalytic material;
raising the filter upwardly until it breaks away from the liquid level of the sol-gel and then leaving the filter to stand statically;
drying the filter saturated with the photocatalytic gel by compressed air and then drying the same by heating so as to form a photocatalytic filter; and
metal-modifying the photocatalytic filter by the use of a photo-deposition process for depositing a metal on the photocatalytic filter for modifying the same;
wherein, the metal modification of the photocatalytic filter further comprises the steps of:
preparing an aqueous solution of a metal salt;
submerging the photocatalytic filter in the aqueous solution for performing the photo-deposition process thereon;
repetitively performing a water-washing process and a centrifugal process on the photocatalytic filter; and
drying the photocatalytic filter.

12. The method of claim 11, wherein the filter provided is a porous ceramics filter made of a mixture of aluminum oxide and silicon carbide, and the porosity of the porous ceramics filter is ranged between 5 ppi and 50 ppi.

13. The method of claim 11, wherein the photocatalytic material contained in the sol-gel is a material selected from a titanium dioxide (TiO₂), a zinc oxide (ZnO), a tin dioxide (SnO₂) and the mixtures thereof, while enabling the photocatalyst content of the sol-gel to be ranged between 0.01 wt % and 50 wt %.

14. The method of claim 11, wherein the grain-diameter of each selected photocatalytic material powder contained in the sol-gel is ranged between 5 nm and 1 um.

15. The method of claim 11, wherein the providing and the impregnating of the filter is performed in a manner that a ceramics filter is provided and submerged in a sol-gel for about 5 minutes.

16. The method of claim 15, wherein the raising of the filter upwardly is perform in a manner that the filter is raised at a speed of 1 cm to 20 cm per minute and is then being left to stand statically after it breaks away from the liquid level of the sol-gel.

17. The method of claim 16, wherein the drying of the filter is performed by blow-drying the ceramics filter impregnated with the sol-gel by compressed air and then placing the ceramics filter in an oven for baking the same for a period of time ranged between four and twenty-four hours at a temperature between 150 to 600° C. so as to fix the photocatalytic material on the surface of the ceramics filter.

18. The method of claim 11, wherein the concentration of metal ion in the aqueous solution is ranged between 0.005 and 1N.

19. The method of claim 11, wherein the pH value of the aqueous solution is ranged between 6 and 12.

20. The method of claim 11, wherein the photo-deposition process is activated by illuminating the photocatalytic filter submerged in the aqueous solution by ultraviolet light emitted from a light source whereas the light source is a ultraviolet device selected from the group consisting of: an ultraviolet high pressure mercury lamp, a black light tube lamp, a light-emitting diode, and a germicidal lamp.

21. The method of claim 20, wherein the wavelength of the ultraviolet light is smaller than 390 nm.

22. The method of claim 20, wherein the intensity of the ultraviolet light measured on the surface of the photocatalytic filter is higher than 0.2 mW/cm².

23. The method of claim 20, wherein the duration of the ultraviolet light illuminating on the photocatalytic filter is between 0.5 hour and 12 hours.

24. The method of claim 11, wherein the water-washing process and centrifugal processes are performed repetitively two to five times.

25. The method of claim 11, wherein the drying of the photocatalytic filter is performed by placing the metal-modified photocatalytic filter in an environment with temperature ranged between 60 to 100° C. for a period of time between four to twenty-four hours.
